(19) United States
(12) Patent Application Publication
(10) Pub. No.: US 2003/0225940 A1
(43) Pub. Date: Dec. 4, 2003

(54) System and method for acquiring data in a processing unit

(76) Inventors: Oliver Daigle, Verdun (CA); Francois Mainguy, Quebec (CA)

Correspondence Address: NIXON & VANDERHYE P.C., 8th Floor, 1100 North Glebe Road, Arlington, VA, 22201, US

(21) Appl. No.: 10/157,026

(22) Filed: May 30, 2002

(51) Int. Cl. G06F 3/00

(52) U.S. Cl. 710/1

(57) ABSTRACT

The present invention provides a system and a method for fail-safe data acquisition, based on splitting an acquisition operation between a communication unit and an processing unit linked together by a shared memory through which transfer of data between the communication unit and the processing unit is done so that the acquisition of data may not be jeopardized by a crash of the processing unit. The method comprises starting the communication unit and the processing unit so that the memory shared between the communication unit and the processing unit is created through which transferring data is allowed from the data acquisition unit via the communication unit to the processing unit; and responding to a crash of the processing unit shoud the processing unit crash.

### FIELD OF THE INVENTION

The present invention relates to computing. More specifically, the present invention is concerned with a system and method for acquiring data in a processing unit.

### BACKGROUND OF THE INVENTION

It Is a well-known fact in the field of computing that applications running on a computer system may not be unfailingly stable. Indeed, although meticulously programmed, applications are deemed to crash once in the hands of an end-user. With the rising number of third party libraries available for use in computer programs nowadays, chances are high that errors arise in the most unpredicted situations, which can bring down important applications.

When acquiring data with a hand-held device for example, either in the medical field or in other fields where data are needed for real-time analysis or display by an application, it is desirable that in case of a crash of the application, the data are not lost or damaged. Such a crash of the application usually occurs when using an non-initialized pointer. For example, in a case when a memory pointed by the pointer is vacated, this pointer becomes invalid, i.e the pointer points nowhere even though its value has not changed. An application using such an invalid pointer is deemed to crash. In the specific example of applications such as GUI (“Graphic User Interface”), oftentimes a sequence of commands that have not been determined before hand and that are issued by the user may result in using a pointer that is not valid any longer.

Therefore, there is a need for a system and method that allow acquiring data in a computer system while providing a protection to prevent lost or damages of the data in the case when the application that uses the data crashes.

### OBJECTS OF THE INVENTION

An object of the present invention is therefore to provide an improved system and method for data acquisition in a processing unit.

### SUMMARY OF THE INVENTION

The present invention provides a system and a method for acquiring data in a processing unit in a reliable way. Such a system and method for data acquisition are based on involving:

a communication unit in a data acquisition process from a source of data through a data acquisition unit;

a processing unit such as an interface program or a user interface for instance; and

a pool of memory that is shared between the communication unit and the processing unit and through which the data transfer.

It is to be noted that the expression ‘computer system’ is not intended herein in any limited way. The expression must be so construed as to include any system or device capable to process data via a processing unit, including, but not limited to: a personal computer, a computer, and a hand-held measuring device.

The expression ‘processing unit’ should be construed so as to include any electronic or integrated circuit configured or programmed to process data, including reading, performing computation on, and transferring such data, a processing unit programmed with a user interface, etc.

More precisely, the system and method for fail-proof data acquisition comprise linking the communication unit and the processing unit by the provision of the pool of shared memory in such a way, referred to as “CPU-wise”, that a processor or CPU is used in an efficient manner without unnecessary operations in the process of acquiring the data from the data source and without reducing the acquisition rate. Should a crash occur in the processing unit, due to the provision of the communication unit and the pool of shared memory on the path of the data, the data are not endangered by the failing processing unit, since they are transferred by means of write-protected data blocks of the pool of shared memory. In such a system, a crash of the processing unit does not jeopardize the data acquisition process.

Considering that the system and method for fail-safe data acquisition in a processing unit according to the present invention involve an additional data transfer layer, care is taken so that this layer uses a minimum amount of the resources of the processor so as to allow an acquisition rate equivalent to that currently obtained in non fail-safe systems and methods for data acquisition.

Therefore, in accordance with the present invention, there is provided a system for acquiring data in a processing unit from a data source, the system comprising: a data acquisition unit; a communication unit connected to the data acquisition unit coupled to the data source; and a memory shared between the communication unit and the processing unit; whereby a transfer of data from the data source via the data acquisition unit to the processing unit is performed through the communication unit via the memory shared between the communication unit and the processing unit.

In accordance with a second aspect of the present invention there is provided a method for fail-safe data acquisition comprising: starting a communication unit connected to a data acquisition unit, the data acquisition unit being coupled to a data source by a data acquisition unit, launching an application unit; and providing a pool of shared memory between the communication unit and the application unit; whereby the pool of memory shared between the communication unit and the application unit allows data to be transferred from the data acquisition unit via the communication unit to the application unit.

In accordance, with a third aspect of the present invention, a fail-safe system for acquiring data in a processing unit from a data source connected to a data acquisition unit, the system comprising: a communication unit connected to the data acquisition unit coupled to the data source; and a memory shared between the communication unit and the processing unit; whereby all the data from the data source are transferred via the data acquisition unit to the processing unit through the communication unit via the memory shared between the communication unit and the processing unit.

Other objects, advantages and features of the present invention will become more apparent upon reacting of the following non-restrictive description of specific embodiments thereof, given by way of example only with reference to the accompanying drawings.

### BRIEF DESCRIPTION OF THE DRAWINGS

In the appended drawings,:

FIG. 1 is a block diagram of a system according to an embodiment of a first aspect of the present invention, and

FIGS. 2A-2C present a flowchart of a method according to an embodiment of a second aspect of the present invention.

### DETAILED DESCRIPTION

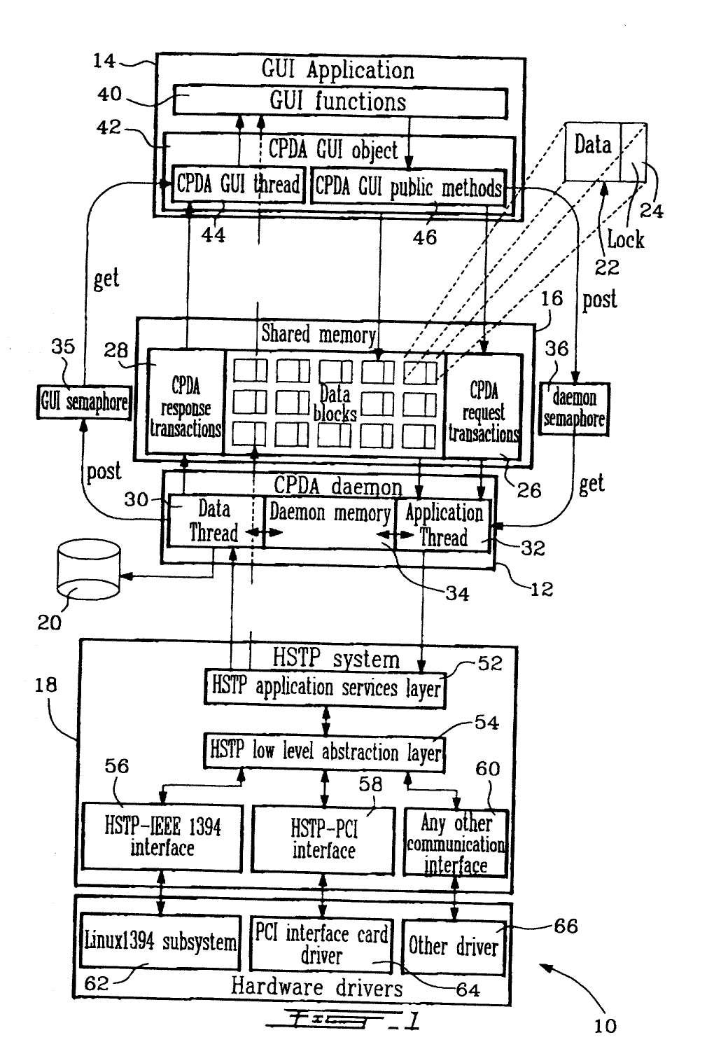

Turning now to FIG. 1 of the appended drawings, a system 10 for fail-safe data acquisition in a processing unit according to an embodiment of a first aspect of the present invention will be described.

According to the example of FIG. 1, the system 10 is part of a hand-held measuring device (not shown) allowing to collect data from a data source (not shown) using a data acquisition unit such as a sensor (not shown) connected to the measuring device, and to display information related to the collected data onto a display monitor (not shown).

Such measuring devices are well known in the art and will not be described herein more detail.

The system 10 for fail-safe data acquisition in a processing unit comprises a communication unit referred to as a CPDA daemon 12, (note that CPDA stands for “crash proof data acquisition”), and a processing unit, herein exemplified as a GUI (“Graphic User Interface”) application 14, linked together by a pool of shared memory 16. It is to be understood that although the word “daemon” is commonly used in Unix environments, the present invention is not limited to be implemented in Unix environments.

The communication unit 12 is to be connected to the sensor (not shown) of the hand-held device (not shown) via a data transport system 18.

The pool of shared memory 16 allows a high rate of data flow between the CPDA daemon 12 and the GUI 14. Data acquired by the CPDA daemon 12 from a data acquisition unit (not shown) conveying data from the source of data (not shown) that is passed to the GUI 14 via by the pool of shared memory 16 is advantageously fail-proof against a crash of the GUI 14 as will be explained with further details hereinbelow.

Data that do not transit through the pool of shared memory 16 provided between the CPDA daemon 12 and the GUI 14, for example in the case when the GUI 14 establishes a direct link to the data acquisition unit (not shown) thus bypassing the pool of shared memory 16 and the CDPA daemon 12, are not safe against a crash of the GUI 14. However, in some applications or systems, it may be conceived that some of the data bypasses the pool of shared memory 16. Additionally, for example, an application 14 may have a direct link with the data acquisition unit (not shown) upon launching thereof. Once this application is launched however, this direct link may be canceled to allow the data to flow through the shared memory 16.

The GUI 14 comprises a GUI functions unit 40 that allows on with an end-user (not shown) and a CPDA GUI object unit 42. The CPDA GUI object unit 42 further comprises a CPDA GUI thread 44 and a CPDA GUI public methods unit 46. The GUI functions unit 40 interacts with the CPDA GUI object unit 42 to make requests to the CPDA daemon 12. Therefore the GUI functions unit 40 does not communicate directly with the CPDA daemon 12. The function of each of these components will be described hereinafter.

The CPDA daemon 12 comprises a data thread 30, a communication unit application thread 32 and a daemon memory 34 between the data thread 30 and the communication unit application thread 32.

The CPDA daemon 12 monitors the data transport system 18, in order to initiate a transfer of data from the source of data (not shown) that provides the data to be processed, i.e, to receive the data and, if requested, to save them to a storing unit 20, exemplified in this example by a disk file, whose name is provided by the GUI 14. The CPDA daemon 12 also transfers data to the GUI 14 upon request therefrom, as will be further described hereinbelow. Obviously, the storing unit 20 may take many form, including: DVD, CD, disk or hard drive. Random-Access Memory (RAM), Read-Only Memory (ROM), a tape back-up, etc.

There are three different modes of operation of the CPDA daemon 12 that The user can select from:

1. “Request-data” mode: in this mode, the data provided from the source of data shown) to the CPDA daemon 12 via the data acquisition unit (not shown) are passed to the GUI 14 upon request. To this effect, the incoming data must adjust to a flow requested by the GUI 14, as will be explained further hereinbelow. Such a mode where no data is stored may be selected when the user requires making adjustments before launching an acquisition for example.

2. “Every-data” mode: in this mode, the data provided from the source of data (not shown) via the data acquisition unit (not shown) are first saved to the storing unit 20 and then passed to the GUI 14 by the CPDA daemon 12 upon request. The incoming data flow must adjust to the flow requested by the GUI 14, as will be explained further hereinbelow. Such a mode is advantageous when the user wishes to proceed to a very accurate acquisition and therefore needs to visualise all the data that are being acquired.

3. “Acquire-data” mode: in this mode, which is essentially a high-speed acquisition mode, the data provided from the source of data (not shown) are saved to the storing unit 20 by the CPDA daemon 12 and a number of them are transferred to the GUI 14 upon request for display for example. Such a mode allows the user to monitor the acquisition of data without over-soliciting the resources of the CPU by displaying huge amounts of data. The data flow does not have to adapt to the flow requested by the GUI 14.

As mentioned hereinabove, in the request-data mode and in the ever-data mode, the incoming data flow must adjust to the flow requested by the GUI 14. This flux adaptation is monitored by the data transport system 18. More precisely, upon reception of a request from the GUI 14, the data thread 30 of the CDPA daemon 12 reads the flux of incoming data delivered by the data transport system 18. The data transport system 18 verifies that the data sent by the data acquisition unit (not shown) fit in its reception buffer. Whenever the reception buffer of the data transport system 18 is full, the data transport system 18 notifies the data acquisition unit (not shown) to stop sending data until a block of data has been requested by the GUI 14. Once a block of data has been received by the GUI 14, thereby allowing emptying of the reception buffer of the data transport system 18, the data transport system 18 notifies the data acquisition unit (not shown) that new data can be sent. Such a flux adaptation is referred to in the art as “flow control”. Flow control is well-known in data transport system of the connected type such as HSTP (for “High-Speed Transport Protocol”) or TCP (for “Transmission Control Protocol”) for instance (as opposed to non-connected data transport system such as IP for “Internet Protocol” and UDP for “User Datagram Protocol” for example), to avoid loss of data.

To avoid duplication of data between both the CPDA daemon 12 and the GUI 14, which results essentially in a waste of time, the reception of data from the source of data through the data transport system 18 by the CPDA daemon 12 may be done directly to a data block 22 of the shared memory pool 16. According to this way of transferring data, the CPDA daemon 12 is not required to copy an input buffer to pass it to the GUI 14, since the input buffer is already at a proper place to do so in the pool of shared memory 16. Moreover, data blocks 22 passed to the GUI 14 are each provided with a lock 24, so that as long as the lock 24 is on the data blocks 22 can not be overwritten by the GUI 14. This allows the GUI 14 to make efficient use of the received data without possibility to modify, damage or destroy them.

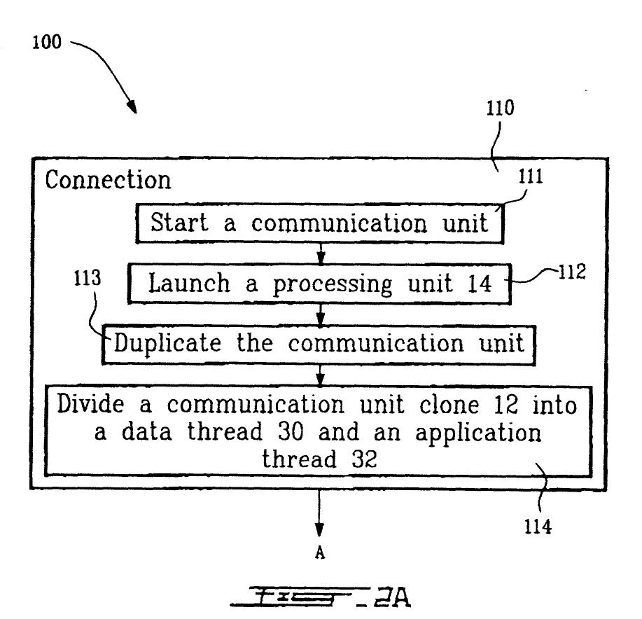

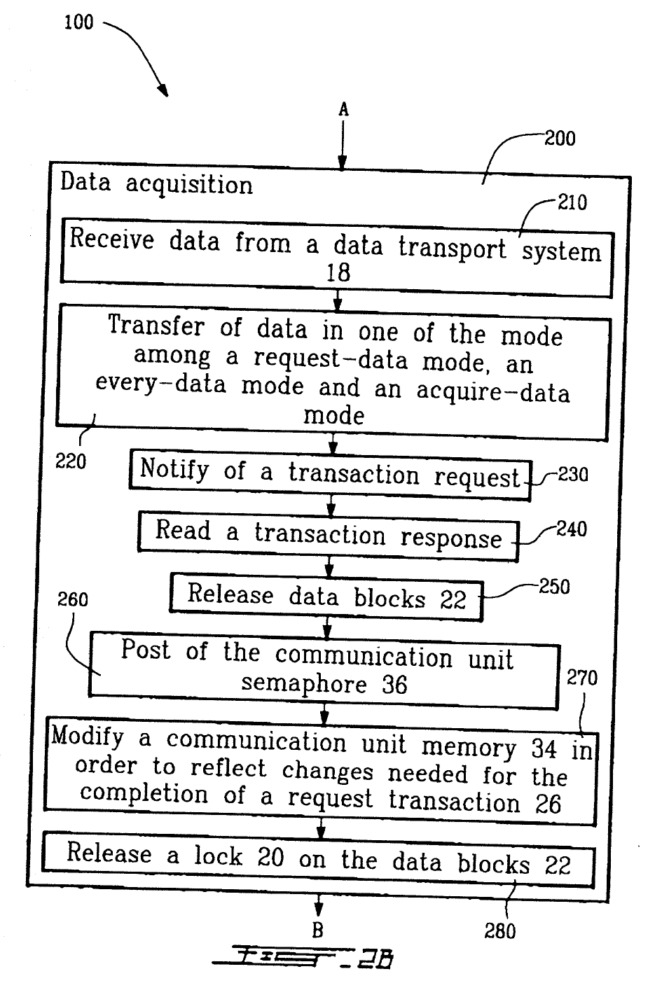

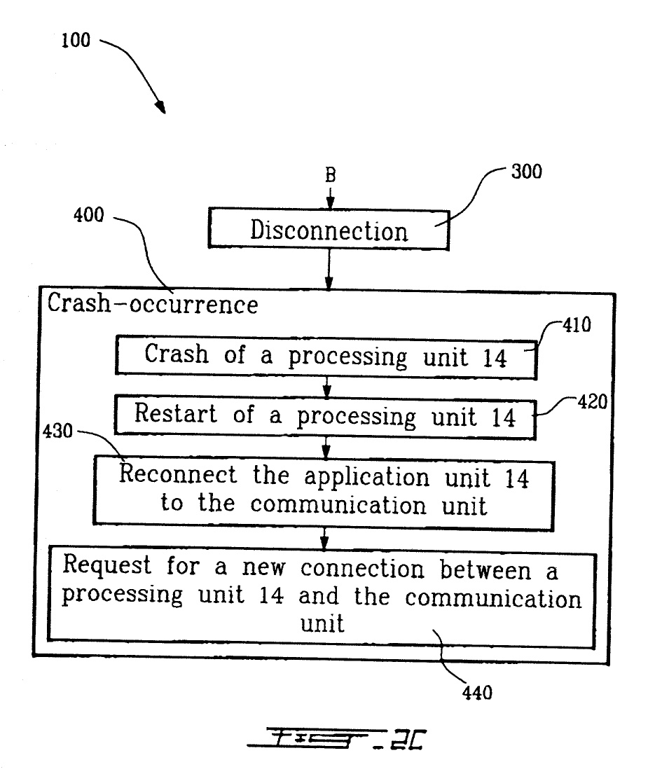

Data transfers between the CPDA daemon 12 and The GUI 14 are done through CPDA request transactions 26 for data transfers from the GUI 14 to the CDPA daemon 12, and through CPDA response transactions 28 for data transfers from the CDPA daemon 12 to the GUI 14. The data block 22 containing the data to be transferred may be attached to the CPDA request transaction 26 or the CPDA response transaction 28. The CPDA daemon 12 and the GUI 14 notify each other of a request for a transfer of data by means of a GUI semaphore 35 and a daemon semaphore 36 respectively, in a way that will be described hereinbelow in relation to FIG. 2.

It should be understood that a fail-proof acquisition system according to the present invention allows dealing with cases when an application running on a processing unit 14 crashes and a faulty pointer disturbs a memory in the shared memory pool 16. In such an event, as data may be directly received to a data block 22 of the shared memory 16 by the CPDA daemon 12, the GUI 14 is prevented from corrupting these data before they are saved to the storing unit 20, by the provision of write-protecting data blocks 22 passed to the GUI 14.

The data transport system 18 allows to receive and send data from the data acquisition unit (not shown) through software communications handlers such as low level hardware drivers 62, 64 and 66, comprising Linux 1394 subsystem, PCI interface card driver or other drivers, for example.

The data transport system 18 is a HSTP system for example, comprising a HSTP processing unit service layer 52 communicating with a HSTP IEEE 1394 interface 56 (also known as “Firewire”), a HTSP personal computer interface (“PCI”) 58 or other communication interface 60, via a HSTP low level abstraction layer 54 In order to communicate on a PCI bus or on a IEEE 1394 bus by means of the HSTP protocol, an interface module is needed between the HSTP and the PCI.

It is to be emphasized that although the fail-proof system 10 for data acquisition of the present invention is exemplified herein to interface itself to the HSTP protocol, other data transport protocol can be used between an source of data (not shown) and the CDPA daemon 12, such as a TCP/IP protocol, in which case Ethernet could be a material layer allowing the transmission of data. Person skilled in the art will appreciate that a minimal programming effort is sufficient to implement other data transport systems or other data sources.

It is also believed to be within the reach of a person skilled in the art to incorporate an acquisition system according to the first aspect of the present invention to other devices requiring transfer of data from a data source to a processing unit.

As a further aspect of the present invention, a fail-proof data acquisition method 100 is provided that is now described through an embodiment thereof in relation to FIGS. 2A-2C.

The fail-proof data acquisition method 100 comprises a connection stage 110 (FIG. 2A), a data acquisition stage 200 (FIG. 2B), a disconnection stage 300 (FIG. 2C) and a crash monitoring stage 400 (FIG. 2C).

In a first stage 110, a fail-proof data acquisition system according to the first aspect of the present invention, such as system 10, is to be connected as described hereinbelow.

This involves, in a first step 111, that the communication unit 12 is started. The communication unit 12 then creates a message box provided with an identification key, and waits for messages received in this message box. Such a message box is known in the field of inter-unit communication of sysV type, as are semaphores and the shared memory. The message box allows to exchange data between units. It has a memory nature, for example a kernel memory. It Is to be noted that the message box is being used herein as an easy and effective way to implement a communication between units that have no kinship to begin with. Obviously, a socket, a pipe or even a file may be used instead as the message box.

Once an processing unit 14 is launched by the user and an processing unit object 42 is created, the processing unit object 42 provides a zone of shared memory 16 with the communication unit as well as two semaphores, namely the communication unit semaphore 36 and the processing unit semaphore 35. Two other semaphores are created by the processing unit 14: a first one allows to assess a number of available data blocks 22, and a second one used by the processing unit 14 to notify the communication unit that a new data block 22 is needed. The processing unit 14 saves identification keys of the blocks 22 of the pool of shared memory 16 and of the semaphores in a dedicated file (Step 112).

It is to be noted that in fact, a semaphore is used by the processing unit 14 to request, not directly a data block 22, but a set of data provided by the data acquisition unit (not shown). Should such a set of data be larger than a data block 22, the communication unit splits it into several data blocks 22, so that the semaphore sent by the processing unit 14 may result in the transfer of more than one data blocks 22 to the processing unit 14, depending on the size of the data set provided by the data acquisition unit (not shown).

When the processing unit 14 sends the identification keys of the blocks 22 of the pool of shared memory 16 and of the semaphores to the communication unit via the message box, the communication unit duplicates itself so as to create a clone 12 thereof, which connects to the shared memory 16 and to the semaphores created before by the processing unit 14 (Step 113). The clone 12 is created through a function “C fork( )” for example, in Unix environment, which copies the whole memory of a unit into a shell of a new unit to yield two identical units. The fork function identifies the child unit (clone) with “0” and issues a unit identification of the newly created clone 12 to the parent unit. Although the example described herein makes use of a fork function known to Unix user, people skilled in the art are aware that similar functions exist in every multi-process (unit) operating systems.

The communication unit clone 12 comprises a data thread 30 and a communication unit application thread 32 (step 114), while the parent communication unit that originated the communication unit clone 12 goes on expecting a message in the message box and keeps track of a process number corresponding to created communication unit clones 12, since there might be a plurality of communication unit clones simultaneously. Therefore, data transfers occur between the processing unit 14 and at least one communication unit clone 12 of a parent communication unit 12. It is to be noted there may be also a plurality of processing units 14 simultaneously.

Then, in a further stage 200, a transfer of data can start for fail-proof data acquisition (FIG. 2B)

In a step 210, a data thread 30 of the communication unit clone 12 receives data from the lower data transport system 18, save it to a storing unit 20 if requested and then pass it to the processing unit 14 if requested through the CDPA response transaction 28 and the data block 22 in read-only memory (from the processing unit 14 point of view) after locking the data block 22 with the lack 24.

In the request-data mode or in the every-data mode, the data thread 30 waits for processing unit 14 to request a set of data, which, as explained hereinabove in relation to step 112, may result in one or more data blocks 22, protected in writing (from the processing unit 14 point of view), and creates a CDPA response transactions 28 to which incoming data are attached. Additionally, in the every-data mode, the data may be saved on the storing unit 20. In the acquire-data mode, the data thread writes the data on the storing unit 20, prior to creating a data block 22 protected in writing, and a CDPA response transactions 28, to which incoming data are attached, upon request of the processing unit 14 (step 220).

Then in step 230, in case a block of memory data 22 must be transferred, the communication unit clone 12 posts the processing unit semaphore 35 to notify the processing unit 14 that a CDPA response transaction 28 is ready to be read. The CPDA processing unit thread 44 is triggered when the processing unit semaphore 35 is posted by the data thread 30 of the communication unit clone 12.

The CPDA processing unit application thread 44 then reads the CPDA response transaction 28 and signals the processing unit functions unit that an event occurred (step 240). If this event has data attached to it through a data block 22, the CPDA processing unit application thread 44 passes a pointer to this data block 22 to the processing unit functions unit 40.

As mentioned hereinabove, when the processing unit functions unit 40 is finished with a given data block 22, this data block 22 may be released by unlocking the lock 24 thereof (step 250). Once released, the data block 22 may be used again by a communication unit clone 12.

When the processing unit functions unit 40 requests to communicate with a communication unit clone 12, the processing unit public methods unit 46 emits a CPDA request transaction 26 (step 260). If data have to be transferred to the communication unit clone 12, they are stored into the data block 22 attached to the CPDA request transaction 26, with the lock 24 on (so that it is protected against writing), before the processing unit public methods unit 46 posts the communication unit semaphore 36.

When the communication unit semaphore 36 is posted by a CPDA public methods bloc 46 of the processing unit 14, the communication unit application thread 32 then reads the CPDA request transaction 26 and accordingly modifies the communication unit memory 34 of the clone 12 in order to reflect changes needed for the completion of this CPDA request transaction 26 (step 270). It is to noted that the communication unit memory 34 is “atomically” modified, which will be understood by a person skilled in the art as meaning immediately and with no chance of the modifications being half-completed or of another being interspersed, in a way that the modifications cannot be altered by interrupts or context switch.

In cases when data are attached to the CPDA request transaction 26 through a data block 22, the communication unit application thread 32 releases the lock 24 on this data block 22 as soon as the data are not needed anymore (step 280). This data block 22 is then available to be used again. In cases when the processing unit 14 requests the communication unit application thread 32 to send data through the data transport system 18, the communication unit application thread 32 handles this request directly by contacting the data transport system 18.

In case when a crash of the processing unit 14 occurs when the data acquisition protection system 10 is in the request-data or in the every-data mode, the flow of incoming data is suspended since the processing unit 14 is not able to read them. If such a crash occurs when the data acquisition protection system 10 is in the acquire-data mode, the flow of incoming data is not interrupted since it does not have to adapt to be in synchronisation with the processing unit 14 in the first place: the data keep on being saved in the storing unit 20; however they are not transferred to the crashed processing unit 14 until the processing unit 14 is restarted and reconnected to the communication unit, and thus able to resume data transfer therewith.

The data acquisition protection system 10 can be disconnected as is now described in relation to stage 300 (FIG. 2C). Disconnection can be caused by the following:

1. the processing unit 14 requires a stop of the transfer of data;

2. the data transfer link between a communication unit clone 12 and the data acquisition unit (not shown) is disabled; or

3 a communication unit clone 12 is requested to end its activities, so that it should notify the processing unit 14 and detach itself from the pool of shared memory 16 and from the semaphores, before destroying itself. People skilled in the art will know that such destruction consists in the communication unit clone 12 activating an Exit function, or a closing of its main function, for example. The parent communication unit then is notified of the cancellation of a communication unit clone 12, cancels this communication unit clone 12 from its list of communication unit clones 12 and resume expecting messages.

In case where the parent communication unit is requested to end its activities, the parent communication unit so notifies each of the communication unit clones 12 (see case 3 hereinabove) and once they are cancelled, the parent communication unit destroys the message box and destroys itself in turn, by activating an Exit function, or by closing of its main function, for example.

Obviously, an important stage of the data acquisition method 100 is the crash-monitoring stage 400 (FIG. 2C).

When connecting to a communication unit, a processing unit 14 sends the communication unit a processing unit identification number. This processing unit identification number is advantageously a 32-bits number that uniquely identifies the processing unit 14. The communication unit keeps for each connection the processing unit identification number associated therewith.

Whenever the processing unit 14 crashes (step 410), existing data transfer links between the communication unit and the data acquisition unit are maintained by the communication unit, so that nothing else than the processing unit 14 is affected.

More precisely, in cases when the data acquisition protection system 10 operates in an every-data mode or in a request-data mode, the transfer of data is suspended since there is no processing unit 14 available to receive them, but the existing different units remains operative. In the case where the data acquisition protection system 10 operates in an acquire-data mode, data keep being received and saved on the storing unit 20, even though there is no processing unit 14 to request data blocks 22 from the communication unit.

When the processing unit 14 is restarted after a crash (step 420), the processing unit 14 connects to the pool of shared memory 16 and semaphores, which identification keys that can be recovered from the file created during a first launch of the processing unit 14 (see step 111 of stage 110 hereinabove) The processing unit 14 then attempts to reconnect to the communication unit by sending these identification keys thereto.

Should the communication unit have a connection available for that specific processing unit identification, the communication unit 12 sends back a confirmation of reconnection, and the data acquisition stage 200 can start over as if no crash of the processing unit 14 had ever occurred (step 430).

In the request-data mode or the every-data mode, it may happen that the data acquisition unit cancels the connection after the expiry of a certain delay between successive transfers of data occurring between the processing unit 14 and the communication unit. In such cases, the communication unit 12 may have no connection available for the specific processing unit identification sent by a processing unit 14 requesting reconnection, so that this processing unit 14 cannot connect back to the pool of shared memory 16 and semaphores according to a previous connection, which was cancelled upon disconnection by the communication unit. The processing unit 14 must therefore request a new connection with the communication unit (step 440) along the steps of stage 110 described hereinabove.

Obviously, in an acquire-data mode, no such thing can happen since the transfer links remains active whatever happens.

From the foregoing, a person skilled in the art will appreciate that in the system and method of the present invention, acquisition and processing unit are independent, so as to handle occurrences of a crash of the processing unit. More specifically, the system and method of the present invention allow a real-time recording of data to be unaltered by a crash of a processing unit. The crash is detected and the processing unit is immediately re-launched by an action exterior to the system 10, either automatically or by an action of the user.

Furthermore, it will be apparent to a person skilled in the art that the system and method of the present invention allow for a recording of data at a maximum speed on a hard disk, while taking only a reduced time to update a screen for example. Thus, display events of a graphical window environment are smoothly executed in a main loop without stacking and eventually overloading an event queue, resulting in a saturation of the CPU and accumulation of latency between acquired images and displayed images.

Interestingly, the CDPA system of the present invention can be used in a system devoid of a graphical interface such as a GUI, and provided with another type of application that interacts with a user. Although the invention was described hereinabove by means of a specific example comprising a GUI, it is to be understood that other applications or programs can be involved.

Although the present invention has been described hereinabove by way of preferred embodiments thereof, it can be modified, without departing from the spirit and nature of the subject invention as defined in the appended claims.

What is claimed is:

1. A system for acquiring data in a processing unit from a data source, the system comprising:
a data acquisition unit;
a communication unit connected to the data acquisition unit coupled to the data source; and
a memory shared between said communication unit and the processing unit;
whereby a transfer of data from the data source via the data acquisition unit to the processing unit is performed through said communication unit via said memory shared between said communication unit and the processing unit.

2. The system for acquiring data according to claim 1, wherein said communication unit comprises a data thread, a communication unit application thread and a communication unit memory shared between said data thread and said communication unit application thread.

3. The system for acquiring data according to claim 1, wherein the processing unit comprises a functions unit that interacts with an end-user and an object unit, said object unit further comprising a processing unit thread and a public methods unit, whereby said functions unit interacts with said object unit to make a request to said communication unit.

4. The system for acquiring data according to claim 1, further comprising a data transport system monitored by said communication unit to initiate a data acquisition with from the data acquisition unit that provides data to be used by the processing unit.

5. The system for acquiring data according to claim 1, wherein said communication unit is provided with a mode of operation selected from the group consisting of a request-data mode, an every-data mode and an acquire-data mode.

6. The system for acquiring data according to claim 1, wherein said communication unit allows a request-data mode, an every-data mode and an acquire-data mode, from which a user can choose.

7. The system for acquiring data according to claim 1, further comprising a storing unit where said communication unit may save data received from the data acquisition unit.

8. The system for acquiring data according to claim 1, wherein said memory shared between said communication unit and the processing unit comprises at least one data block and provides that data acquired by said communication unit that is passed to the processing unit transit by said memory shared between said communication unit and the processing unit.

9. The system for acquiring data according to claim 8, wherein said communication unit may receive data directly from a data transport system through one of said at least one data block.

10. The system for acquiring data according to claim 9, wherein said data transport system allows to receive data from low level hardware drivers and to send data to low level hardware drivers.

11. The system for acquiring data according to claim 9, wherein said data transport system is selected in the group comprising a HSTP protocol, a data transport protocol and a TCP/IP protocol.

12. The system for acquiring data according to claim 8, wherein each one of said at least one data block that is passed to the processing unit is provided with a lock, whereby said at least one data block can not be overwritten by the processing unit as long as said lock is on said at least one data block.

13. The system for acquiring data according to claim 1, wherein said communication unit and the processing unit communicate through request transactions and response transactions.

14. The system for acquiring data according to claim 13, wherein a data block of said memory shared between said communication unit and the processing unit and containing data to be transferred may be attached to said request transactions and response transactions.

15. The system for acquiring data according to claim 1, wherein said communication unit and the processing unit notify each other of a request for a transfer of data by means of a semaphore.

16. The system for acquiring data according to claim 3, wherein said processing unit thread, when a semaphore is posted by said public method unit, reads a request transaction and accordingly modifies a memory of said communication unit in order to reflect changes needed for completion of said request transaction.

17. The system for acquiring data according to claim 16, wherein said communication unit application thread releases a lock on a data block of said memory shared between said communication unit and the processing unit used to attach data to the request transaction, as soon as said processing unit thread does not need the data anymore.

18. The system for acquiring data according to claim 1, wherein said processing unit is programmed with a user interface.

19. The system for acquiring data according to claim 1, wherein said processing unit is a graphical user interface.

20. A method for data acquisition using the system recited in claim 1 comprising:
starting the communication unit and the processing unit whereby the memory shared between the communication unit and the processing unit is created through which transferring data is allowed from the data acquisition unit via the communication unit to the processing unit;
transferring the data between the processing unit and the communication unit; and
responding to a crash of the processing unit shoud the processing unit crash.

21. The method for data acquisition according to claim 20, wherein said method further includes disconnecting the processing unit.

22. The method for data acquisition according to claim 21, further including reconnecting the processing unit following a disconnection.

23. The method for data acquisition according to claim 20, wherein said starting the communication unit includes creating a message box provided with an identification key so that the communication unit waits for messages received in the message box.

24. The method for data acquisition according to claim 20, wherein said starting the processing unit includes:
creating semaphores; and
saving identification keys of the memory shared between and of the semaphores.

25. The method for data acquisition according to claim 20, wherein said transferring data comprises:
sending a key of a semaphore from the processing unit to the communication unit;
duplicating the communication unit into at least one clone thereof, which connects to the memory shared between the communication unit and the processing unit, and to the semaphore;
whereby said transferring of data is allowed between the at least one clone and the processing unit, while the communication unit goes on expecting a message in the message box and saves a process number corresponding to the at least one clone.

26. The method for data acquisition according to claim 25, wherein said duplicating the communication unit into at least one clone thereof further includes the at least one clone into creating a data thread and a communication unit application thread connected together by a communication unit memory.

27. The method for data acquisition according to claim 25, wherein said transferring data further includes:
receiving the data by one of the at least one clone;
transferring the data according to a mode selected in the group comprising a request-data mode, an every-data mode, and an acquire-data mode;
posting a semaphore by the communication unit to notify the processing unit of a request transaction;
reading the request transaction by the processing unit;
modifying the communication unit memory to reflect changes needed for completion of the request transaction; and
giving directly a request of the processing unit to send data through a data transport system, by contacting the data transport system.

28. The method for data acquisition according to claim 27, wherein said transferring the data according to a request-data mode and an every-data mode comprises:
requesting a data block protected in writing by the processing unit to the data thread, and
creating a response transaction to which data are attached.

29. The method for data acquisition according to claim 27, wherein said transferring the data according to an acquire-data mode comprises.
storing the data by the data thread; and
creating a data block protected in writing and a response transaction, to which are attached incoming data, upon request of the processing unit.

30. The method for data acquisition according to claim 27, wherein said modifying the communication unit memory includes atomically modifying the communication unit memory.

31. The method for data acquisition according to claim 21, wherein said disconnecting the processing unit includes an action selected from the group consisting of;
stopping a transfer of data to a clone of the communication unit by the processing unit;
disabling data transfer links between a clone of the communication unit and the data acquisition unit;
disabling data transfer links between a clone of the communication unit and a data transport system; and
stopping a clone of the communication unit.

32. The method for data acquisition according to claim 31, wherein said stopping a clone of the communication unit includes:
notifying of the processing unit by the clone of the communication unit;
detaching the clone from the memory shared between the communication unit and the processing unit, and semaphores;
destroying the clone: and
notifying of the communication unit

33. The method for data acquisition according to claim 22, wherein said reconnecting the processing unit comprises:
starting the communication unit so that the communication unit creates a message box provided with an identification key and waits for messages received in the message box,
starting the processing unit so that the memory shared between the processing unit and the communication unit, as well as with semaphores, are created;
saving identification keys of the memory shared between the processing unit and the communication unit and of the semaphores;
duplicating the communication unit into at least one clone thereof, which connects to the memory shared between the processing unit and the communication unit and to the semaphores; and
dividing the at least one clone into a data thread and an communication unit application thread, while the communication unit goes on expecting a message in the message box and keeps track of a process number corresponding to the at least one clone.

34. The method for data acquisition according to claim 20, wherein said responding to a crash of the processing unit includes:
creating a processing unit identification number that uniquely identifies the processing unit upon connection with the communication unit;
storing for each connection the processing unit identification number associated therewith, by the communication unit;
maintaining existing data transfer links between the communication unit and the data acquisition unit, by the communication unit;
reconnecting the processing unit to the memory shared between the processing unit and the communication unit and to the semaphores, which identification keys can be recovered from a file created during a first launch of the processing unit;
requesting reconnection of the processing unit to the communication unit by sending the identification keys thereto; and
reconnecting the processing unit to the communication unit according to one option selected in the group comprising:
using a previous connection to the communication unit; and
requesting a new connection for the processing unit to said communication unit.

35. A method for fail-safe data acquisition comprising:
starting a communication unit connected to a data acquisition unit, the data acquisition unit being coupled to a data source by a data acquisition unit; and
launching an application unit; and
providing a pool of shared memory between the communication unit and the application unit:
whereby the pool of memory shared between the communication unit and the application unit allows data to be transferred from the data acquisition unit via the communication unit to the application unit.

36. A fail-safe system for acquiring data in a processing unit from a data source connected to a data acquisition unit, the system comprising:
a communication unit connected to the data acquisition unit coupled to the data source; and
a memory shared between said communication unit and the processing unit;
whereby all the data from the data source are transferred via the data acquisition unit to the processing unit through said communication unit via said memory shared between said communication unit and the processing unit.
